(19) United States
(12) Patent Application Publication
(10) Pub. No.: US 2008/0019224 A1
(43) Pub. Date: Jan. 24, 2008

(54) Focusing Method and Optical Disk Device

(76) Inventor: Hiromichi Ishibashi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/661,761

(22) PCT Filed: Sep. 14, 2005
(86) PCT No.: PCT/JP05/16919

§ 371 Date: Mar. 2, 2007

(30) Foreign Application Priority Data
Sep. 14, 2004 (JP) 2004-266378

(51) Int. Cl. G11B 7/085

(52) U.S. Cl. 369/30.03

(57) ABSTRACT

An optical disk device comprising a first light source of a first wavelength, a second light source of a second wavelength, first and second objective lenses for focusing light beams of the first and second wavelengths at a predetermined position, an actuator supporting the first and second objective lenses and movable between first and second positions, focus detecting means, focus computing means for outputting a focus error signal and controlling means for, on receiving the focus error signal, controlling the on/off of the first and second light sources and the position of the actuator in a first direction generally perpendicular to a major surface of the loaded optical disk. While the actuator is moving from the first position to the second position or from the second one to the first one, a semi-focused state is detected from the focus error signal outputted from the focus computing means.

### TECHNICAL FIELD

The present invention relates to a method of determining the type of optical disk, each type of which has different protective layer thickness from another, using an optical head equipped with light sources for emitting a plurality of types of light having different wavelengths and focusing the light, and an optical disk device employing this method.

### BACKGROUND ART

Recently, a standard known as a Blu-ray Disc (hereinafter referred to as BD) has been newly created in addition to a compact disc (hereinafter referred to as CD) and a digital versatile disc (hereinafter referred to as DVD). The BD standard has one of its features in focusing a laser of a blue-violet wavelength band (around 405 nm) from a laser light source through a protective layer, which has a substrate thickness of 0.1 mm and is transparent with respect to the light from the light source, using an objective lens having a high numerical aperture of NA=0.85 and attaining a huge volume of 25 GB for a size of 12 cm. Since a disk of BD has the same size (diameter of 12 cm) as those of CD and DVD, BD is expected to become a CD, DVD compatible medium (medium handled with the same drive). However, if a disk among such three type disks is loaded, it is necessary to determine which medium has been mounted, and to switch to the light source of an appropriate wavelength and to the objective lens of an appropriate NA.

Patent documents 1, 2, and 3 disclose conventional arts in the technical field of same kind. Patent document 1 (JP-10-208368-A) discloses a technique wherein an objective lens of an optical pickup is switched to an objective lens for CD to detect the amplitude value of a focus error signal, and then, the objective lens is switched to an objective lens for DVD to perform similar process. Two pieces of data on the amplitudes are compared to determine the type (DVD or CD) of the mounted optical disk.

Patent document 2 (JP-10-261258-A) discloses another technique wherein difference between light detector outputs for light of 640 nm wavelength from a light source for DVD and for light of 780 nm wavelength from a light source for CD and CD-R. More specifically, an optical disk is firstly irradiated with light of 640 nm wavelength and secondly irradiated with light of 780 nm wavelength to determine the type of the optical disk by comparing levels of readout signals obtained from irradiation of light of each wavelength.

Patent document 3 (JP-11-283319-A) discloses yet another technique wherein a laser beam for CD is irradiated to a rotating optical disk for preventing from occurring unintended overwriting or erasing, and then, an objective lens for focusing the light to the disk is moved toward the disk. The type of the disk is determined from a waveform of the focus error signal obtained from light beam reflected from the disk while the objective lens is moved.

Patent Document 1: Japanese Patent Laid-Open Publication No. 10-208368-A.

Patent Document 2: Japanese Patent Laid-Open Publication No. 10-261258-A.

Patent Document 3: Japanese Patent Laid-Open Publication No. 11-283319-A.

### DISCLOSURE OF INVENTION

### Problem to be Solved by the Invention

However, in the conventional configuration, it is necessary to turn all light sources on when the type of disk is determined from two or more types of disk medium including BD. This requires a great time. In addition, light of a particular wavelength corresponding to another medium standard is sometimes irradiated onto a recording surface, which may cause unexpected damages. In the invention disclosed in Patent document 3, the rotating optical disk and the objective lens may contact in case when focus search fails by some chance, which may damage the disk surface. In particular, an optical disk having a thin protective layer such as BD may be seriously damaged.

The object of the present invention is to provide a focusing method for rapidly determining the standard of the disk without damaging the disk, and an optical disk device using this method.

### Means for Solving Problem

The present invention, in one aspect, provides an optical disk device including: a first light source that exits a light of first wavelength; a second light source that exits a light of second wavelength; a first objective lens and a second objective lens that collects light of the first wavelength and light of the second wavelength, respectively, at a predetermined position; an actuator that supports the first objective lens and the second objective lens and that is movable between a first position close to a mounted optical disk and a second position away therefrom; a focus detector that receives the light of the first wavelength and the light of the second wavelength, and outputs a signal corresponding to state of received light; a focus calculator that receives the output of the focus detector and outputs a focus error signal; and a controller that receives the focus error signal, which is an output from the focus calculator, and controls turning ON of the first light source and the second light source, and a position of the actuator in a first direction substantially perpendicular to a major surface of the mounted optical disk; and wherein: the controller includes a focus error signal determining section; and the focus error signal determining section detects a semi-focused state from the focus error signal outputted from the focus calculator while the actuator moves from the first position to the second position or from the second position to the first position.

In one aspect of the present invention, the actuator preferably includes a contact preventing member configuring one part of a surface of the actuator; and at least one portion of the contact preventing member configures a closest end of the actuator with respect to the mounted optical disk.

In one aspect of the present invention, the first position is preferably a position where the closest end configured with the contact preventing member of the actuator contacts the mounted optical disk.

In one aspect of the present invention, the controller preferably further includes an actuator position monitoring section that monitors the position of the actuator.

In one aspect of the present invention, the controller preferably further includes a hold signal generating section for generating a hold signal for having the actuator be in a stationary state over a predetermined period.

In one aspect of the present invention, the device further preferably includes a motor that moves the actuator in a second direction perpendicular to the first direction and parallel to the radial direction of the mounted optical disk; and a stopper that suppresses the movement in the second direction of the optical disk or the direction toward the inner peripheral part of the mounted disk at a predetermined position; and wherein the controller further includes an innermost periphery movement command generating section, controls the motor, and moves the actuator in the second direction to a position contacting the stopper.

In one aspect of the present invention, the device preferably further includes an eject switch; and a non-volatile memory, and wherein the controller stores an eject flag related to a pressed history of the eject switch in the non-volatile memory and further includes an eject flag determining section that determines state of the eject flag.

In one aspect of the present invention, the device preferably further includes a spindle motor that rotates the mounted optical disk, and wherein the controller controls rotation of the spindle motor and has the focus error signal determining section perform detection of a semi-focused state with the spindle motor in stopped state.

In one aspect of the present invention, the device preferably further includes a third light source that exits a light of third wavelength and a third objective lens that collects the light of third wavelength at a predetermined position, and wherein: the actuator supports the third objective lens; the focus detector receives the light of third wavelength and outputs a signal corresponding to the state of the received light; and the controller controls turning ON of the third light source.

In one aspect of the present invention, the second objective lens and the third objective lens are preferably configured with a common lens.

In one aspect of the present invention, the first wavelength is preferably around 405 nanometers, the second wavelength around 650 nanometers, and the third wavelength around 780 nanometers.

In another aspect, the present invention provides a focusing method of detecting an information recording surface of an optical disk mounted on an optical disk device using light of first wavelength and light of second wavelength, the method including: determining the presence or absence of a recording surface at a first depth of the mounted optical disk by irradiating the light of first wavelength and detecting a semi-focused state without rotating the mounted optical disk; determining the presence or absence of a recording surface at a second depth of the mounted optical disk by irradiating the light of second wavelength and detecting a semi-focused state without rotating the mounted optical disk; and performing focusing.

In another aspect, the present invention provides a focusing method for determining the type of standard of a mounted optical disk and performing focusing in an optical disk device including a plurality of light sources emitting light of wavelengths different from each other, an actuator which supports the plurality of light sources and is movable between a first position close to the optical disk and a second position away therefrom, a means for generating a focus error signal based on the light emitted by at least one of the plurality of light sources, and a controller which controls the plurality of light sources and the actuator and can receive the focus error signal, comprising: moving the actuator to the first position in a first direction, which is a direction substantially perpendicular to a major surface of the mounted optical disk; turning ON a first light source of the plurality of light sources; monitoring a first focus error signal based on a light emitted by the first light source and closing a focus control loop when detecting a semi-focused state while moving the actuator from the first position to the second position; turning ON a second light source of the plurality of light sources; monitoring a second focus error signal based on a light emitted by the second light source and closing a focus control loop when detecting a semi-focused state while moving the actuator from the first position to the second position; turning ON a third light source of the plurality of light sources; and monitoring a third focus error signal based on a light emitted by the third light source and closing a focus control loop when detecting a semi-focused state while moving the actuator from the first position to the second position.

In another aspect of the present invention, the mounted optical disk is preferably in a stationary state during the monitoring a first focus error signal, the monitoring a second focus error signal, and the monitoring a third focus error signal.

In another aspect of the present invention, the first light source emits a light having a wavelength of around 405 nanometers; the second light source emits a light having a wavelength of around 650 nanometers; and the third light source emits a light having a wavelength of around 780 nanometers.

In another aspect of the present invention, the actuator preferably includes a contact preventing member configuring one part of the surface of the actuator and at least one portion of the contact preventing member configuring a closest end of the actuator with respect to the mounted optical disk; and the moving the actuator to the first position includes moving the actuator to the first position which is the position where the closest end of the actuator contacts the mounted optical disk.

In another aspect of the present invention, the optical disk device preferably includes a spindle motor for rotating the mounted optical disk; the controller can control the spindle motor; and the monitoring a first focus error signal includes stopping the movement of the actuator over a predetermined period when a semi-focused state is detected, starting the rotation of the spindle motor connected to the mounted optical disk, releasing the stopping of the actuator after a predetermined period has elapsed, and closing the loop of the focus control loop.

In another aspect of the present invention, the optical disk device preferably includes a motor for moving the actuator in a direction substantially perpendicular to the first direction and substantially parallel to a second direction which is the radial direction of the mounted optical disk and a stopper for suppressing the movement of the actuator in the second direction; the controller can control the motor; and the method further comprises: moving the actuator in a direction substantially perpendicular to the first direction and substantially parallel to the second direction which is the radial direction of the mounted optical disk; and stopping the movement of the actuator at a position where the light emitted by the first light source and the second source is irradiated onto a predetermined region positioned on the innermost peripheral part of the mounted optical disk.

In another aspect of the present invention, the predetermined region is preferably a pre-pit area of the mounted optical disk.

In another aspect of the present invention, the actuator is preferably moved, the first light source is turned ON, and the monitoring a first focus error signal is executed to detect the semi-focused state by the first light source; where if the semi-focused state is not detected from the first focus error signal in the monitoring, the actuator is moved, the second light source is turned ON and the monitoring a second focus error signal is executed to detect the semi-focused state by the second light source; where if the semi-focused state is not detected from the second focus error signal in the monitoring, the actuator is moved, the third light source is turned ON and the monitoring a third focus error signal is executed to detect the semi-focused state by the third light source.

In another aspect of the present invention, the optical disk device preferably includes an eject switch that mounts and de-mounts the optical disk and a memory that stores the eject flag related to the pressed history of the eject switch, and the method includes: reading the eject flag related to the pressed history of the eject switch; and determining whether the eject flag is turned ON or OFF; where the actuator is moved, the first light source is turned ON and the monitoring a first focus error signal is executed if determined that the eject flag is turned ON in the determining; the actuator is moved, the second light source is turned ON and the monitoring a second focus error signal is executed if the semi-focused state is not detected from the first focus error signal in the monitoring; and the actuator is moved, the third light source is turned ON and the monitoring a third focus error signal is executed if the semi-focused state is not detected from the second focus error signal in the monitoring.

In another aspect of the present invention, preferably, the monitoring a first focus error signal further includes turning OFF the state of the eject flag; the monitoring a second focus error signal further includes turning OFF the state of the eject flag; and the monitoring a third focus error signal further includes turning OFF the state of the eject flag.

### Effect of the Invention

The focusing method according to the present invention and the optical disk device using the method allow accurate and rapid determination of the type of the optical disk without damaging the information recording surface and the surface of the optical disk.

### BRIEF DESCRIPTION OF DRAWINGS

FIG. 1 is a schematic diagram of configuration of an optical disk device according to the first embodiment of the present invention.

FIG. 2A is a flow chart of a focusing method according to the first embodiment.

FIG. 2B is a flow chart of the focusing method according to the first embodiment.

FIG. 3A is an explanatory diagram of the operation of the focusing method according to the first embodiment.

FIG. 3B is a typical profile example of a focus error signal detected in states b to d of FIG. 3A.

FIG. 3C is a typical profile example of a focus error signal detected in states e to g of FIG. 3A.

FIG. 4 is a schematic diagram of configuration of an optical disk device according to the second embodiment of the present invention.

FIG. 5A is a flow chart of a focusing method according to the second embodiment.

FIG. 5B is a flow chart of the focusing method according to the second embodiment.

FIG. 6 is a diagram of relation of the focus error signal and signals generated by a controller.

FIG. 7 is a schematic diagram of configuration of an optical disk device according to the third embodiment of the present invention.

FIG. 8A is a flow chart of a focusing method according to the third embodiment.

FIG. 8B is a flow chart of the focusing method according to the third embodiment.

FIG. 9 is a schematic diagram of configuration of an optical disk device according to a fourth embodiment of the present invention.

FIG. 10A is a flow chart of a focusing method according to the fourth embodiment.

FIG. 10B is a flow chart of the focusing method according to the fourth embodiment.

### EXPLANATIONS OF LETTERS OR NUMERALS

100, 200, 300, 400: optical disk device
101: optical disk
102: optical head
104, 204, 304, 404: controller
104a: focus error signal determining section
104b: actuator position monitoring section
105: spindle motor
110b, 110r, 110ir: information recording surface
121, 122: objective lens
123: contact preventing member
125, 126, 127: laser light source
128, 129: focus detection light receiving element
135, 136: focus calculating section
201: focus error signal FEB
203: focus error signal threshold value Vth
204a: hold signal generating section
205: hold signal
207: actuator driving current
209: motor control signal
211: focus control signal
304a: innermost periphery movement command generating section
306: motor
362: stopper
404a: eject flag determining section
407: eject switch
408: scale

### BEST MODE FOR CARRYING OUT THE INVENTION

Embodiments of the present invention will now be described with reference to the drawings.

### First Embodiment

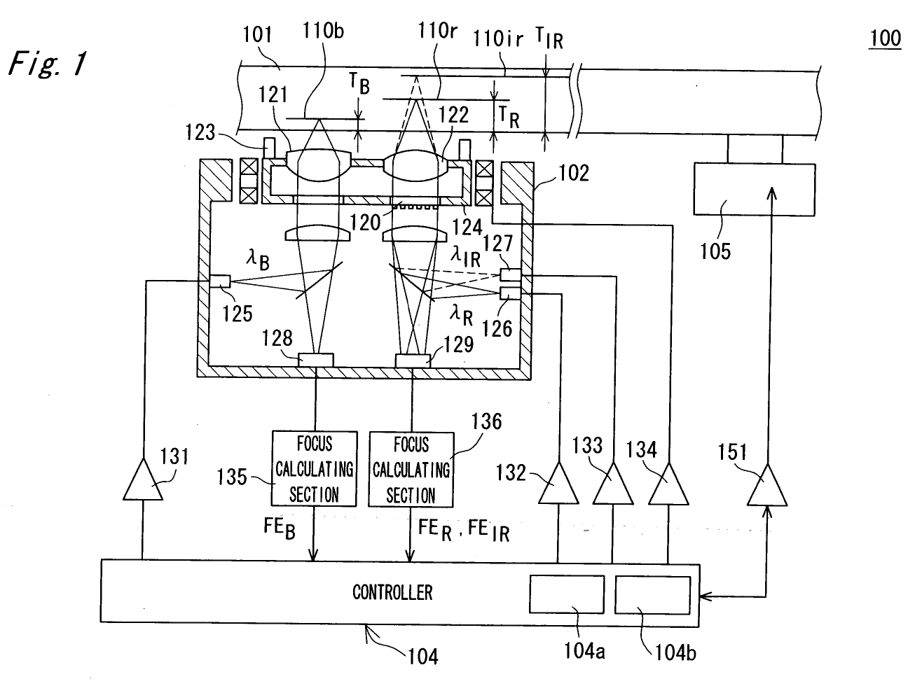

FIG. 1 is a schematic diagram of configuration of an optical disk device according to the first embodiment of the present invention. Referencing to FIG. 1, the optical disk device 100 includes an optical head 102. The optical head 102 includes laser light sources 125, 126 and 127, and the light exited from the light sources is irradiated onto an optical disk 101 mounted on the optical disk device 100 through an objective lens 121 or 122. The laser light source 125 can exit a light (blue light (B) having a wavelength (lambda_B) of around 405 nm). The laser light source 126 can exit a light (red light (R)) having a wavelength (lambda_R) around 650 nm. The laser light source 127 can exit a light (infrared light (IR)) having a wavelength (lambda_IR) around 780 nm. The blue light exited from the laser light source 125 enters the optical disk 101 through the objective lens 121, and converges to an information recording surface 110b at a predetermined depth TB from the disk surface of the light source 125 side. The red light exited from the laser light source 126 and the infrared light exited from the laser light source 127 pass through a wavelength-selective hologram 120, enter the optical disk 101 through the objective lens 122 and converge at the information recording surfaces 110r and 110ir, respectively, at predetermined depths TR and TIR from the disk surfaces on the light sources 126 and 127 sides. The optical disk device 100 may only include two of the laser light sources 125, 126 and 127. The optical disk device complying with a plurality of medium standards can be configured by including two of the above light sources. The wavelength emitted by the light source is selected so as to adapt to the medium standard to be reproduced or recorded.

The objective lenses 121, 122 are integrally supported by an actuator 124, and the objective lenses 121 and 122 are both movable in a direction of moving closer to or moving away from the optical disk 101 when the actuator 124 is electromagnetically driven. The actuator 124 includes a contact preventing member 123 to prevent the objective lens 121 or 122 from contacting the disk surface. The upper end of the contact preventing member 123 is on the optical disk 101 side than the upper end of the objective lenses 121 and 122. The contact preventing member 123 is formed by a soft material such as Duracon® so that the surface of the optical disk 101 will not be damaged when the actuator 124 moves closer to the optical disk 101 and the contact preventing member 123 contacts the surface of the optical disk 101. “Duracon” is a resin having polyoxymethylene as its main component and is a registered trademark of Polyplastic Co. Ltd. A configuration in which the red light and the infrared light are collected at the objective lens 122 has been described, but a configuration of collecting them at separate object lenses may also be adopted. In this case, the actuator 124 integrally supports three objective lenses.

The optical disk device 100 includes focus detection light receiving elements 128 and 129 serving as a focus detector for receiving the light exited from the light sources 125, 126 and 127 and reflected at the optical disk 101, which focus detection light receiving elements 128 and 129 transmit the output corresponding to the received light to focus calculating sections 135 and 136. The focus calculating sections 135 and 136 serving as focus calculator are circuits which can obtain focus error signals FEB, FER, and FEIR using a well known calculation method based on the input from the focus detection light receiving elements 128 and 129, and output the signals to a controller 104.

The controller 104 serving as the controlling means includes microprocessor, DSP or the like, and can execute the program based on the focusing method of the present invention. The controller 104 can drive laser light source drivers 131, 132 and 133, and each laser light source driver 131, 132, or 133 turns ON or turns OFF the corresponding light source 125, 126, or 127 at a desired output based on the command of the controller 104.

The controller 104 can drive an actuator driver 134, and the actuator driver 134 supplies driving current to the actuator 124 based on the command of the controller 104. The distance between the actuator 124 and the optical disk 101 can be varied by changing the driving current. Furthermore, the present disk device 100 includes a sensor (not shown) arranged at the contact preventing member 123 of the actuator 124, which sensor sends a notification to the controller 104 when sensing the contact of the contact preventing member 123 with the optical disk 101.

The controller 104 can also drive a motor driver 151, and the motor driver 151 can rotate or stop a spindle motor 105 based on the command of the controller 104.

The controller 104 executing a program based on the focusing method of the present invention drives the laser drivers 131, 132 and 133, and the actuator driver 134 to turn ON and OFF the laser light sources 125, 126 and 127, and controls the up and down movement of the actuator 124, determines the type of optical disk 101 based on the focus error signal FEIR, FER and FEB by means of a focus error signal determining section 104a in the controller 104, and executes the focusing. The controller 104 may also include an actuator position monitoring section 104b for constantly monitoring the current position of the actuator 124. In this case, the actuator position monitoring section 104b receives information from the sensor (not shown) sensing the current position of the actuator 124 to know the position of the actuator 124.

The optical disk 101 mounted on the optical disk device 100 has a protective layer on the surface thereof, and interiorly includes at least one information recording surface 110b, 110r, or 110ir. The thickness of the protective layer, that is, the depth from the disk surface to the information recording surfaces 110b, 110r, and 110ir with respect to the respective standards for BD, DVD, and CD, is defined as 0.1 mm (=TB), 0.6 mm (=TR), and 1.1 mm (=TIR), respectively, and the wavelength of the light used as the light source is defined around 405 nm (=lambda_B), 650 nm (=lambda_R), and 780 nm (=lambda_IR), respectively, as the wavelength standard.

The numerical aperture (NAB) of the objective lens 121 forming a light spot on the information recording surface 110b having the protective layer thickness of TB=0.1 mm, which is the narrowest spacing from the optical head 102, is set to 0.85.

The wavelength-selective hologram 120 arranged on the optical path on the light source side of the objective lens 122 forming the light spot on the information recording surface 110r having the protective layer thickness of TR=0.6 mm and the information recording surface 110ir having the protective layer thickness of TIR=1.1 mm acts as a concave lens with respect to the light having an infrared wavelength (lambda_IR). The infrared light that has entered the wavelength-selective hologram 120 enters the objective lens 122 with enhanced degree of diffusion. The wavelength-selective hologram 120 transmits the incident red light as it is, so that the red light enters the objective lens 122. According to the operation of the wavelength-selective hologram 120, the numerical aperture (NAR) with respect to the red light of the objective lens 122 becomes 0.6, and the numerical aperture (NAIR) with respect to the infrared light of the objective lens 122 becomes 0.45.

The optical disk 101 only needs to have one information recording surface 110b, 110r or 110ir at least one depth (protective layer thickness), and does not need to be a multi-layer disk having a plurality of information recording surfaces as shown in FIG. 1.

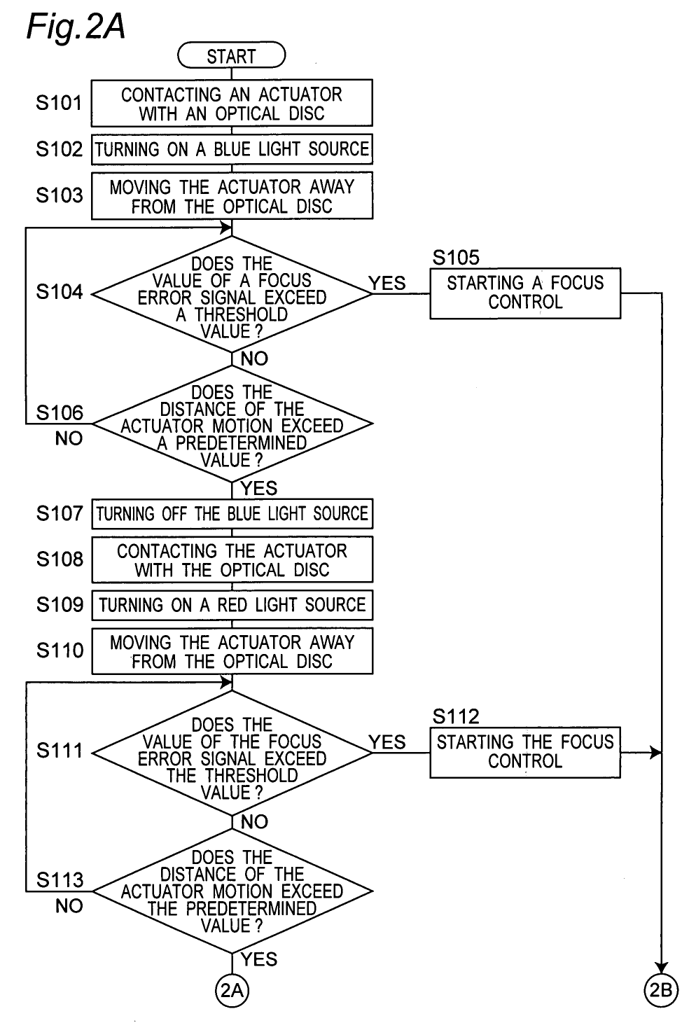

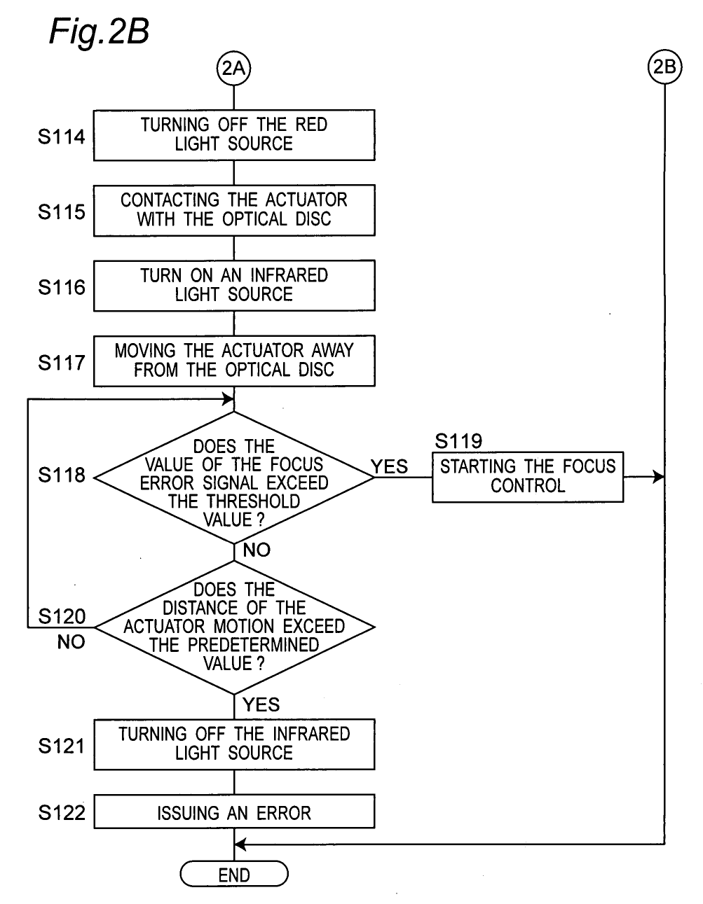

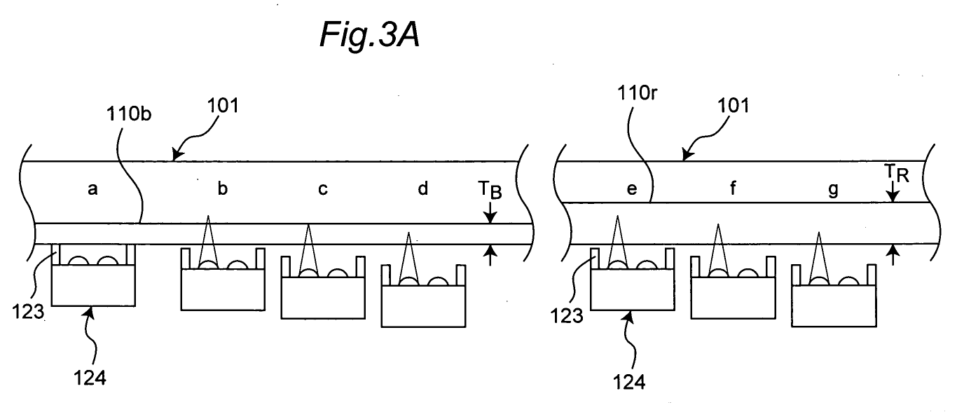

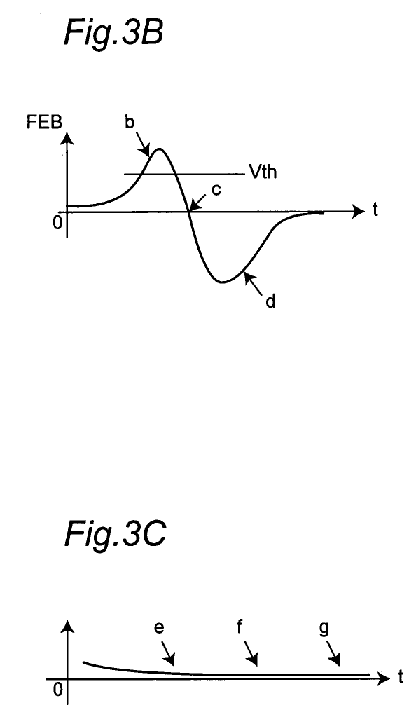

The operation of the controller 104 will now be described using FIGS. 2A, 2B, and 3. FIGS. 2A and 2B are flowcharts of the focusing method of the first embodiment, and FIG. 3 is an explanatory view explaining the operation of the focusing method of the first embodiment.

“Focusing” refers to the operations of determining the standard of the optical disk mounted on the optical disk device, moving the optical head to a range of accurately capturing the focus error signal and turning ON the focus servo (control) loop (close focus servo (control) loop).

The optical disk 101 is assumed to be stationary during the focusing operation in the present embodiment.

[Step S101]

The controller 104 sends a command to the actuator driver 134 to raise the actuator 124 (to approach toward the optical disk 101). The driving current is supplied to the actuator 124 so that the actuator 124 slowly approaches the optical disk 101 and the contact preventing member 123 contacts the surface of the optical disk 101 (see state a in FIG. 3). The distance of motion of the actuator 124 is proportional to the product of the moving speed of the actuator 124 and the movement time at the relevant moving speed. A well known relationship (e.g., proportional relationship) is established between the moving speed and the driving current. The controller 104 flows a predetermined driving current for a predetermined time to realize the contact between the contact preventing member 123 and the optical disk 101. The current value and the current flowing time are stored in the controller 104 in advance, which current flowing time may be measured by a timer and the like incorporable therein. If the controller 104 includes the actuator position monitoring section 104b, the actuator position monitoring section 104b detects the contact of the contact preventing member 123 with respect to the surface of the optical disk 101 based on the signal from the sensor (not shown).

The controller 104 sends a command to the actuator driver 134 to stop the actuator 124 at the relevant position, and the contact preventing member 123 of the actuator 124 comes to rest in a state contacting the optical disk 101. This position (position of the actuator 124 where the contact preventing member 123 is contacting the optical disk 101) is assumed as a first actuator position.

[Step S102]

The controller 104 then sends a command to the laser driver 131 to turn ON the light source 125. The laser driver 131 supplies current to the laser light source 125 and the light source 125 starts to emit blue light (wavelength lambda_B)

[Step S103]

After starting the emission of blue light, the controller 104 gradually moves the actuator 124 with the actuator driver 134 in a direction the objective lens 121 moves away from the optical disk 101 while receiving the focus error signal FEB, which is related to the blue light received by the focus detection light receiving element 128, transmitted from the focus calculating section 135.

In other words, in steps S102 and S103, the focusing operation assuming that a BD (Blu-ray Disc) is mounted on the optical disk device 100 is performed. The blue light exited from the objective lens 121 of NA=0.85 converges at a position slightly deeper than the position where the depth from the disk surface is 0.1 mm in a state that the contact preventing member 123 of the actuator 124 is contacting the optical disk 101 (first actuator position) (corresponds to state a of FIG. 3A). After the actuator 124 starts to move downward (direction of moving away from the optical disk 101) (after step S103), the controller 104 starts the focus search.

If the currently mounted optical disk 101 is BD, the information recording surface 110b (reflective surface) is at a position where the depth is 0.1 mm. The focus (i.e., light collected point) of the blue light traverses the information recording surface 110b (from state b of FIG. 3A through state c to state d) as the actuator 124 moves downward. In other words, the focus of the blue light, starting from a position of non-focused state, gradually lowers and after passing the semi-focused state becomes a focused state, and then further moves from the semi-focused state to a position of non-focused state with respect to the information recording surface 110b. The semi-focused state refers to a state in which the detected focus error signal does not take a value of zero or around zero and indicates a significant non-zero value, and the focused state refers to a state, for example, sandwiched by two regions indicating the semi-focused state, and in which the detected focus error signal indicates zero.

The focus error signal FEB output from the focus calculating section 135 draws a so-called S curve as shown in FIG. 3B. As the focus of light approaches the information recording surface 110b, the focus error signal FEB first increases in the positive direction (state b in FIG. 3B) (semi-focused state). The signal then reaches a positive peak at a position of the focus spaced apart by about 1 to 5 micrometers from the information recording surface. As the focus further approaches the information recording surface 110b, the focus error signal suddenly decreases, and becomes zero at the focused position (state c in FIG. 3B) (focused state). Thereafter, the signal passes the negative peak and converges to zero level (state d in FIG. 3B) (non-focused state) as the focus moves away from the information recording surface 110b. The signal shows the negative peak when the focus is at a position of about 1 to 5 micrometers from the information recording surface 110b.

[Step S104]

When the focus error signal determining section 104a of the controller 104 detects the semi-focused state from the focus error signal FEB, for example, when detecting the S curve in the focus error signal FEB (when detecting at least the portion from state b to state c in the curve of FIG. 3B) (YES in step S104), the mounted optical disk 101 is determined as BD, and the process proceeds to step S105. If not detected (NO in step S104), the process proceeds to step S106. In the focusing operation of the present invention, the medium standard of the mounted optical disk 101 is determined through detection of the semi-focused state, and the normal focus control is started. Thus, the light of high energy density in the focused state is not irradiated to the information recording surface 110b (same applies to 110r and 110ir) of the optical disk 101 in the focusing operation, and thus the optical disk 101 will not be light damaged even if the focusing operation is performed without rotating the optical disk 101. The medium standard of the disk is determined with the optical disk 101 in the stationary state, that is, without rotating the optical disk 101 in the present embodiment, and thus the focusing can be rapidly completed.

The detection of the S curve in step S104 can be carried out by setting a substantially intermediate value of the peak of the assumed S shape (maximum point of the curve contained in state b of FIG. 3) and the zero level as the threshold value (the focus corresponds to the position spaced apart by +0.5 to +2.5 micrometers from the information recording surface 110b at the threshold value herein), and detecting if the focus error signal FEB is greater than or equal to the threshold value. The threshold value does not need to be 50% of the peak value of the assumed value, and only needs to be a value of between 30% and 90% of the assumed peak value. The threshold value is indicated as Vth in FIG. 3B. The semi-focused state may be detected, for example, by obtaining the slope of the focus error signal, and detecting the change in sign of the slope. Moreover, the semi-focused state may be detected, for example, by obtaining the rate of change (secondary derivative of focus error signal) of the slope of the focus error signal, and detecting the inflection point.

[Step S105]

The controller 104 determines the mounted optical disk 101 as BD, and starts the focus control. The controller 104 sends a command to the motor driver 151 to rotate the spindle motor 105, whereby the optical disk 101 starts to rotate.

[Step S106]

The controller 104 determines that the mounted optical disk 101 is not BD (YES in step S106) when the total distance of motion of the actuator 124 is greater than or equal to a predetermined value, that is, when the integral amount related to the current flow time of the driving current is greater than or equal to a predetermined amount and the actuator 124 reaches a predetermined position spaced apart from the optical disk 101 or at a position beyond the predetermined position, and proceeds to step S107. If the total distance of motion is less than the predetermined value (NO in step S106), the process returns to step S104, and continues to accept the input of the focus error signal FEB. The predetermined value may be, for example, the total distance of motion of the actuator 124 of when the actuator 124 lowers to a position where the focus moves out of the optical disk 101. That is, the predetermined value may be the total distance of motion of the actuator 124 of when the focus of the blue light passes through the vicinity of depth of 0.1 mm of the optical disk 101, and further moves to a shallower position. The position of the actuator 124 in a state where the total distance of motion of the actuator 124 is equal to the predetermined value is assumed as a second actuator position. That is, the second actuator position is set below the first actuator position with spacing of the predetermined distance. If the controller 104 includes the actuator position monitoring section 104b, the total distance of motion of the actuator 124 is desirably monitored from the start of movement of the actuator 124 in step S103.

The case in which the semi-focused state is not detected from the focus error signal FEB, that is, the case in which the process proceeds to step S107 without the value of the focus error signal exceeding the threshold value, corresponds to a case in which an optical disk other than BD standard is mounted. For example, if DVD is mounted, the light collecting point of the blue light does not reach the information recording surface 110r even with the optical head 102 pressed against the optical disk 101 because the information recording surface 110r is positioned at a depth of 0.6 mm from the surface of the optical disk 101. The light collecting point of the blue light thus does not traverse the information recording surface 110r, and the S curve is not detected (corresponds to state e, state f and state g of FIGS. 3A and 3B).

[Step S107]

The controller 104 sends a command to the laser driver 131 to turn OFF the light source 125. The laser driver 131 stops the emission of the blue light (wavelength lambda_B) from the laser light source 125. This step is not essential. This is because the blue light will not reach the information recording surface 110r or 110ir and cause damages even if the following steps are executed with the laser light source 125 turned ON. This step is performed for the purpose of improving safety.

[Step S108]

After stopping the emission of the blue light, the controller 104 again contacts the contact preventing member 123 with the surface of the optical disk 101 and stops the same at the relevant position (first actuator position), similarly to step S101.

[Step S109]

The controller 104 sends a command to the laser driver 132 to turn ON the light source 126. The laser driver 132 supplies current to the laser light source 126 and the light source 126 starts to emit red light (wavelength lambda_R).

[Step S110]

After starting the emission of red light, the controller 104 gradually moves the actuator 124 with the actuator driver 134 in a direction the objective lens 122 moves away from the optical disk 101 while receiving the focus error signal FER, which is related to the red light received by the focus detection light receiving element 129, transmitted from the focus calculating section 136.

In other words, in steps S109 and S110, the focusing operation assuming that a DVD is mounted on the optical disk device 100 is performed. The red light exited from the objective lens 122 converges at a position slightly deeper than the position where the depth from the disk surface is 0.6 mm in a state that the contact preventing member 123 of the actuator 124 contacts the optical disk 101. After the actuator 124 starts to move downward (after step S110), the controller 104 starts the focus search.

If the currently mounted optical disk 101 is DVD, the information recording surface 110r (reflective surface) is at a position where the depth is 0.6 mm. The focus (i.e., light collected point) of the red light traverses the information recording surface 110r as the actuator 124 moves downward. In other words, the focus of the red light, starting from a position of a non-focused state, gradually lowers and after passing the semi-focused state becomes a focused state, and then moves from the semi-focused state to a position of non-focused state with respect to the information recording surface 110r.

The focus error signal FER output from the focus calculating section 136 draws a so-called S curve. As the focus of light approaches the information recording surface 110r, the focus error signal FER first increases in the positive direction (semi-focused state). The signal then reaches a positive peak when the focus is at a position spaced apart by 1 to 5 micrometers from the information recording surface. As the focus further approaches the information recording surface 110r, the focus error signal suddenly decreases, and becomes zero (focused state) at the focused position. Thereafter, the signal passes the negative peak and converges at zero level (non-focused state) as the focus moves away from the information recording surface 110r. The signal shows negative peak when the focus is at a position of about 1 to 5 micrometers from the information recording surface 110r.

[Step S111]

Similarly to step S104, when the focus error signal determining section 104a of the controller 104 detects the semi-focused state from the focus error signal FER, for example, when detecting the S curve in the focus error signal FER (YES in step S111), the mounted optical disk 101 is determined as DVD and the process proceeds to step S112. If not detected (NO in step S111), the process proceeds to step S113. The detection of the S curve in step S111 can be performed similarly to the detection of the S curve in step S104.

[Step S112]

The controller 104 determines the mounted optical disk 101 as DVD, and starts the focus control. The controller 104 sends a command to the motor driver 151 to rotate the spindle motor 105, whereby the optical disk 101 starts to rotate.

[Step S113]

Similarly to step 106, the controller 104 determines that the mounted optical disk 101 is not DVD (YES in step S113) when the total distance of motion of the actuator 124 is greater than or equal to a predetermined value, and proceeds to step S114. If the total distance of motion is smaller than the predetermined value (NO in step S113), the process returns to step S111, and continues to accept the input of the focus error signal FER. The predetermined value may be the total distance of motion of the actuator 124 of when the focus of the red light passes through the vicinity of depth of 0.6 mm of the optical disk 101, and further moves to a shallower position. The predetermined value in this case is desirably determined so that the focus of the red light is at a depth of greater than or equal to a depth of 0.1 mm in terms of safety measure on the optical disk 101. The position of the actuator 124 of when the actuator 124 lowers by the total distance of motion may be the same as the second actuator position or may be a different position (third actuator position).

The case in which the semi-focused state is not detected from the focus error signal FER, that is, the case in which the process proceeds to step S114 without the value of the focus error signal exceeding the threshold value, corresponds to a case in which an optical disk other than the DVD standard is mounted. For example, if CD is mounted, the light collecting point of the red light does not reach the information recording surface 110ir even with the optical head 102 pressed against the optical disk because the information recording surface 110ir is positioned at a depth of 1.1 mm from the surface of the optical disk. The light collecting point of the red light thus does not traverse the information recording surface 110ir and the S curve is not detected.

[Step S114]

The controller 104 sends a command to the laser driver 132 to turn OFF the light source 126. The laser driver 132 stops the emission of the red light (wavelength lambda_R) from the laser light source 126. This step is not essential. This is because the red light will not reach the information recording surface 110ir and not cause damages even if the following steps are executed with the laser light source 126 turned ON. This step is performed for the purpose of improving safety.

[Step S115]

After stopping the emission of the red light, the controller 104 again contacts the contact preventing member 123 with the surface of the optical disk 101 and stops the same at the relevant position (first actuator position) similarly to step S101.

[Step S116]

The controller 104 sends a command to the laser driver 133 to turn ON the light source 127. The laser driver 133 supplies current to the laser light source 127 and the light source 127 starts to emit an infrared light (wavelength lambda_IR).

[Step S117]

After starting the emission of infrared light, the controller 104 gradually moves the actuator 124 with the actuator driver 134 in a direction the objective lens 122 moves away from the optical disk 101 while receiving the focus error signal FEIR, which is related to the infrared light received by the focus detection light receiving element 129, transmitted from the focus calculating section 136.

In other words, in steps S116 and S117, the focusing operation assuming that a CD is mounted on the optical disk device 100 is performed. The infrared light exited from the objective lens 122 converges at a position slightly deeper than the position where the depth from the disk surface is 1.1 mm in a state where the contact preventing member 123 of the actuator 124 is contacting the optical disk 101. After the actuator 124 starts to move downward (after step S117), the controller 104 starts the focus search. If the currently mounted optical disk 101 is CD, the information recording surface 110ir (reflective surface) is at a position where the depth is 1.1 mm. The focus (i.e., light collected point) of the infrared light traverses the information recording surface 110ir as the actuator 124 moves downward. In other words, the focus of the infrared light, starting from a position of a non-focused state, gradually lowers and after passing the semi-focused state becomes a focused state, and then moves from the semi-focused state to a position of a non-focused state with respect to the information recording surface 110ir.

The focus error signal FEIR output from the focus calculating section 136 draws a so-called S curve. As the focus of light approaches the information recording surface 110ir, the focus error signal FEIR first increases in the positive direction (semi-focused state). The signal then reaches a positive peak when the focus is at a position spaced apart by 1 to 5 micrometers from the information recording surface. As the focus further approaches the information recording surface 110ir, the focus error signal suddenly decreases, and becomes zero (focused state) at the focused position. Thereafter, the signal passes the negative peak and converges at zero level (non-focused state) as the focus moves away from the information recording surface 110ir. The signal shows negative peak when the focus is at a position of about 1 to 5 micrometers from the information recording surface 110ir.

[Step S118]

Similarly to steps S104 and S111, when the focus error signal determining section 104a of the controller 104 detects the semi-focused state from the focus error signal FEIR, for example, when detecting the S curve in the focus error signal FEIR (YES in step S118), the mounted optical disk 101 is determined as CD and the process proceeds to step S119. If not detected (NO in step S118), the process proceeds to step S120. The detection of the S curve in step S118 can be performed similarly to the detection of the S curve in steps S104 and S111.

[Step S119]

The controller 104 determines the mounted optical disk 101 as CD, and starts the focus control. The controller 104 sends a command to the motor driver 151 to rotate the spindle motor 105, whereby the optical disk 101 starts to rotate.

[Step S120]

Similarly to steps 106 and 113, the controller 104 determines that the mounted optical disk 101 is not CD (YES in step S120) when the total distance of motion of the actuator 124 is greater than or equal to a predetermined value, and proceeds to step S121. If the total distance of motion is smaller than the predetermined value (NO in step S120), the process returns to step S118, and continues to accept the input of the focus error signal FEIR. The predetermined value may be the total distance of motion of the actuator 124 of when the focus of the infrared light passes through the vicinity of depth of 1.1 mm of the optical disk 101, and further moves to a shallower position. The predetermined value in this case is desirably determined so that the focus of the infrared light is at a depth of greater than or equal to the depth of 0.6 mm in terms of safety measure on the optical disk 101. The position of the actuator 124 of when the actuator 124 lowers by the total distance of motion may be the same as either the second actuator position or the third actuator position, or may be a different position (fourth actuator position).

The case in which the semi-focused state is not detected from the focus error signal FEIR, that is, the case in which the process proceeds to step S121 without the value of the focus error signal exceeding the threshold value corresponds to a case in which an optical disk other than the CD standard is mounted.

[Step S121]

The controller 104 sends a command to the laser driver 133 to turn OFF the light source 127. The laser driver 133 stops the emission of the infrared light (wavelength lambda_IR) from the laser light source 127. This step is not essential. This is because there is no information recording surface that may be damaged by the infrared light in the optical disk 101 even if the laser light source 127 is continued to be turned ON. This step is performed for the purpose of improving safety.

[Step S122]

In the processes of step S101 to step S120, the controller 104 issues an “error” and terminates if not responding to any of the BD, DVD or CD standard. This is, for example, when the optical disk is mounted upside down.

Therefore, according to the first embodiment, the focus search (focusing) is performed assuming a disk mounted in the order of shallower information recording surface, that is, in the order of BD, DVD, and CD.

When the BD is mounted, the mounted optical disk 101 can be determined as BD in the processes of step S101 to step S104, when the DVD is mounted, the mounted optical disk 101 can be determined as DVD in the processes of step S101 to step S111, and when the CD is mounted, the mounted optical disk 101 can be determined as CD in the processes of step S101 to step S118. Furthermore, if focusing (searching) (step S102 to step S106) is performed with the BD light source (blue light source (light source 125)) turned ON, the blue light does not reach the information recording surface 110r or 110ir of the optical disk 101 since the focal distance of the objective lens 121 is short regardless of whether the mounted optical disk 101 is CD or DVD, and thus, the information recording surface 110r or 110ir will not be damaged.

In the first embodiment, the optical disk device 100 arranged with the objective lens 121 dedicated to the BD, and also arranged with another objective lens 122 and the hologram 120 for the DVD and the CD is described for the purpose of illustration. However, this does not intend to exclude the application of the present invention to optical heads that use a variable focus lens and the like, which comply to BD, DVD and CD with one lens (for example, using variable focus lens or the like to be put to practical use in the future). Moreover, a case where only one information recording surface is present in one optical disk has been described in the present embodiment, but the present invention is also applicable to a so-called multi-layer optical disk configuration having a plurality of information recording surfaces in one disk. Examples of the multi-layer configuration include some types: the information recording surface of the same standard is formed at an interval of about 40 micrometers as in the DVD dual layer type (8.5 GB); a so-called format compatible disk wherein the information recording surface of the BD standard is arranged at a depth of 0.1 mm from the disk surface and the information recording surface of the DVD standard is arranged at a depth of 0.6 mm; and the like. In either case, the type of the optical disk can be reliably determined and a safe focusing process can be performed by starting the focusing process from the search for the information recording surface corresponding to the light source of a short wavelength.

In the present embodiment, the detection of the focus error signal is performed by moving the actuator 124 to a position contacting the optical disk 101 and gradually lowering the same, but the focusing may be performed by detecting the focus error signal by moving the actuator 124 to a position where the light collected at the objective lenses 121 and 122 converges at a position shallower than the information recording surface 110b, 110r, or 110ir of the optical disk 101, and gradually raising the same.

### Second Embodiment

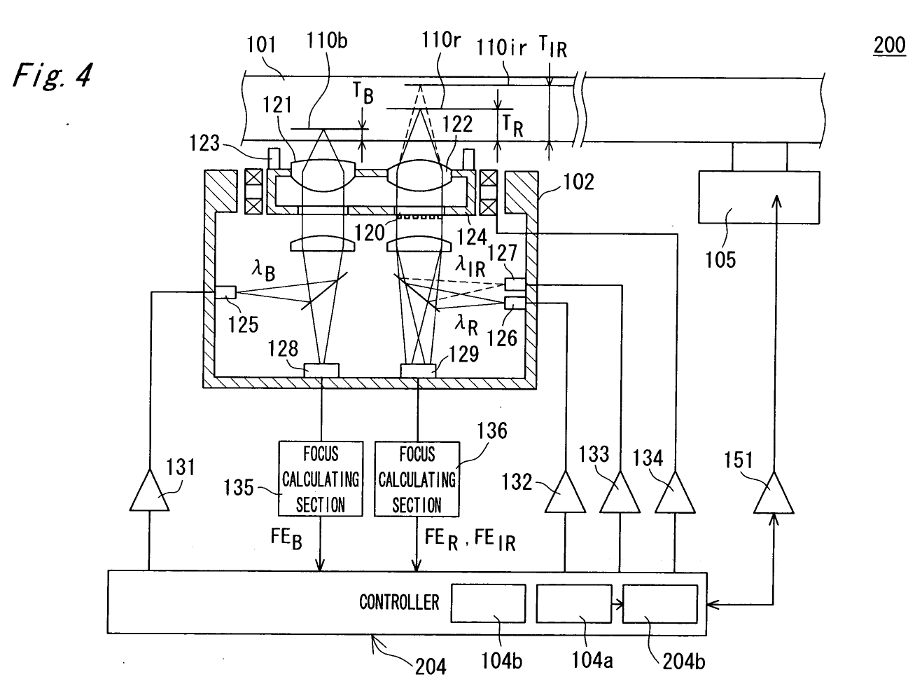

The second embodiment of the present invention will now be described. FIG. 4 is a schematic diagram of configuration of an optical disk device according to the present embodiment. With reference to FIG. 4, an optical disk device 200 includes a controller 204 having a hold signal generating section 204a included in the controller 104 of the optical disk device 100 of the first embodiment. The hold signal generating section 204a generates a hold signal for maintaining the distance between the actuator 124, that is, the objective lenses 121 and 122 and the optical disk 101 constant in a direction substantially perpendicular to the optical disk 101. The position of the actuator 124 is maintained constant while the hold signal is in the ON state. Other than this aspect, the optical disk device 200 may have a configuration similar to the configuration of the optical disk device 100 in the first embodiment. The description of the device configuration other than the above will be omitted in the present embodiment.

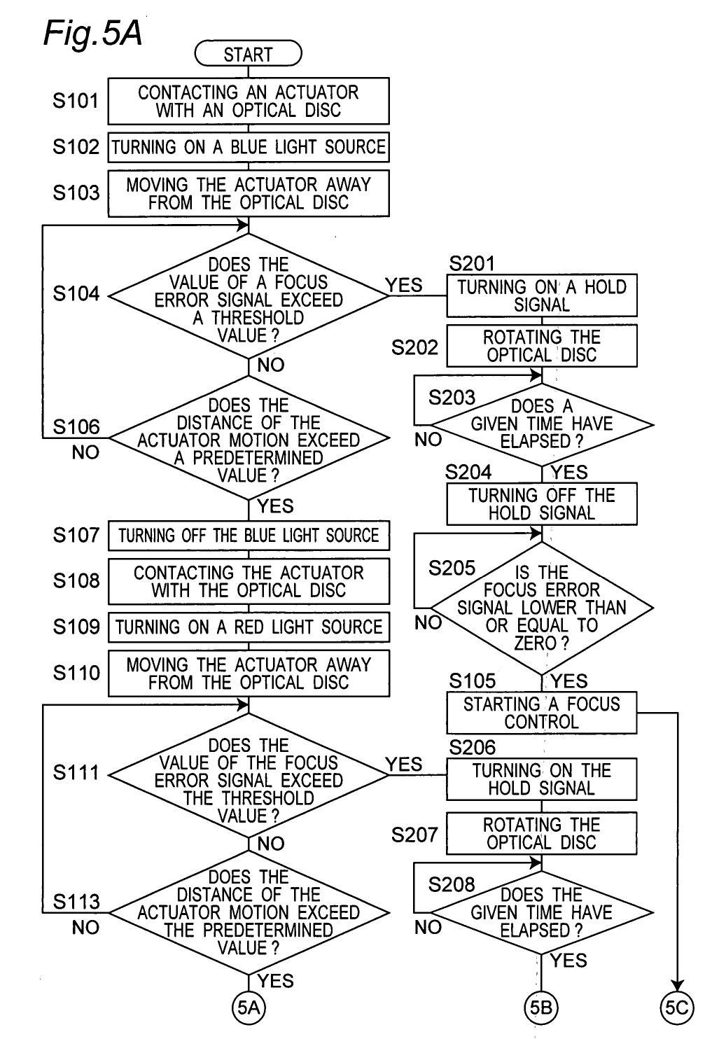

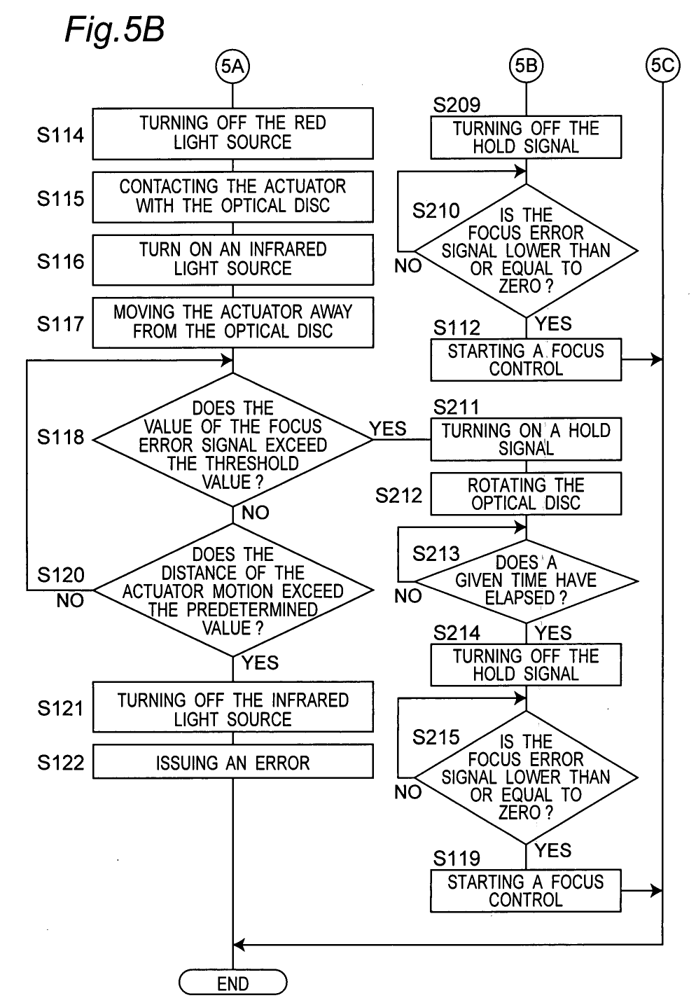

FIGS. 5A and 5B are flow charts of the focusing method of the second embodiment of the present invention.

The steps performing processes similar to the flow chart of the first embodiment (FIGS. 2A and 2B) are denoted with the same reference numerals. The difference between the focusing process (flow charts of FIGS. 5A and 5B) of the present embodiment and the focusing process (flow charts of FIGS. 2A and 2B) of the first embodiment is that when the value of the focus error signal (FEB, FER, or FEIR) obtained by irradiating blue light, red light or infrared light exceeds a threshold value, the hold signal generating section 204a of the controller 204 generates the hold signal (turns ON the hold signal) at the point where the focus error signal FEB, FER or FEIR exceeds a threshold value, holds the position of the optical head 102 in the defocused state, and starts the rotation of the optical disk 101 while the optical head 102 is being held instead of immediately starting the focus control (see steps S105, S112 in FIG. 2A or S119 in FIG. 2B).

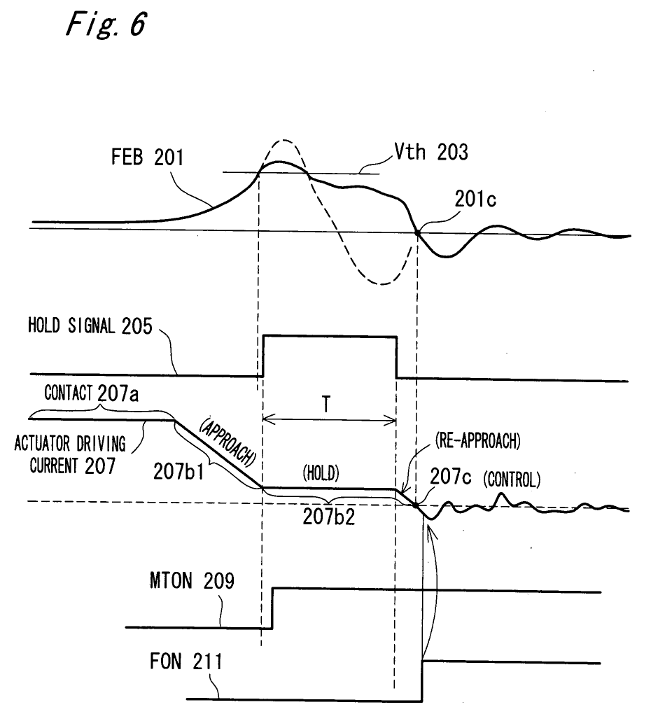

FIG. 6 is a relational view of the hold signal 205 generated by the hold signal generating section 204a of the controller 204, an actuator driving current 207, a signal 209 (MTON) for rotating the motor 105, an ON/OFF state 211 of focus control, and the focus error signal 201 (FEB) at the point where the value of the focus error signal FEB is detected to have exceeded the threshold value and at immediately before and immediately after such point. Similar relationship exists for the focus error signals FER and FEIR. The focusing process of the present embodiment will now be described with reference to FIG. 4, FIGS. 5A and 5B showing the flow charts of the focusing process of the present embodiment, and FIG. 6.

A contacted state (step S101 in FIG. 5A) is achieved (first actuator position) between the optical disk 101 and the contact preventing member 123. An actuator perpendicular position stabilizing spring (not shown) included in the optical head 102 is designed so that the spring force equivalent to the gravitational force acting on the actuator 124 acts on the actuator 124 in a direction opposite to the gravitational force. That is, it is designed so that the actuator 124 is held at a predetermined balanced position by the spring force and the gravitational force when the actuator driving current 207 is not flowing to the actuator 124. The optical disk 101 and the contact preventing member 123 have a predetermined spacing at such balanced position. In order to further raise the actuator 124 to contact the contact preventing member 123 with the optical disk 101, a predetermined driving current must be flowed to the actuator 124 to generate a force acting against the spring force of the actuator perpendicular position stabilizing spring holding the actuator 124. The region 207a of the actuator driving current 207 of FIG. 6 indicates a state in which the predetermined driving current necessary to maintain the contacting state is flowed.

If the actuator perpendicular position stabilizing spring (not shown) is designed so as to act the spring force, which is smaller than the gravitational force acting on the actuator 124, acts on the actuator 124 in a direction opposite to the gravitational force, the profile of the actuator driving current 207 differs from the profile of the present figure. That is, the gravitational force becomes the dominant factor for determining the position of the actuator 124. Therefore, the actuator driving current must exceed the resultant force of the gravitational force acting on the actuator 124 and the normal force acting on the contact preventing member 123 from the optical disk 101, and the actuator driving current that generates a force acting on the actuator 124 in a direction opposite to the resultant force must be flowed to rest the actuator 124 at the first actuator position. An actuator driving current of an extent of generating a force below the gravitational force is flowed in order to lower the actuator 124, and the lowering speed and the acceleration speed are controlled by the size of the actuator driving current. The actuator driving current that generates the force of the same size as the gravitational force acting on the actuator 124 but acting in the opposite direction is flowed in order to have the actuator 124 come to rest at a position that is not the first actuator position.

In step S102, the controller 204 turns ON the blue light source 125.

In step S103, the controller 204 gradually changes (reduces) the current value of the actuator driving current 207 from the current value in the region 207a while receiving the focus error signal FEB 201, and approaches the focus (light collected point) of the objective lens 121 toward the recording surface 110b. The region 207b1 indicates the state in which the actuator driving current 207 is reduced. The optical head 102 and the optical disk 101 are in a relationship corresponding to state b of FIG. 3A.

With reference to FIG. 6, the value of the focus error signal 201 (FEB) increases as the focus of the objective lens 121 approaches the information recording surface 110b. In other words, the focus error signal 201 starts to draw the S curve. When the value of the focus error signal 201 exceeds the threshold value 203 (Vth) (YES in step S104), the focus error signal determining section 104a of the controller 204 sends a command to the hold signal generating section 204a, and the hold signal generating section 204a turns ON the hold signal 205 when receiving the command (step S201). The threshold value 203 (Vth) may be a value of the same level as the threshold value (step S104 of FIG. 2A) in the first embodiment. The up and down movement of the actuator 124 is stopped while the hold signal 205 is in the ON state, and the exited light of the objective lens 121 constantly maintains a defocused state with respect to the information recording surface 110b. The size comparison between the threshold value 203 (Vth) and the focus error signal 201 (FEB) in step S104 may be performed as below. The focus error signal FEB 201 gradually increases from a small value, and even if becoming a value exceeding the threshold value 203 (Vth), the process does not proceed to step S201 at this point, and the actuator 124 continues to be lowered. The focus error signal 201 (FEB) eventually takes a maximum value (see broken line part of FEB of FIG. 6), and thereafter starts to decrease. The focus error signal 201 (FEB) becomes a value equal to the threshold value Vth from a value greater than the threshold value Vth, and then changes to a value smaller than the threshold value Vth. Instead of turning ON the hold signal 205 at the previously described timing, the process may proceed to step S201 and the hold signal may be turned ON at the point when the focus error signal 201 (FEB) becomes a value equal to the threshold value Vth from a value greater than the threshold value Vth.

In step S202, the controller 204 outputs the motor rotating signal 209 (MTON) to the motor driver 151. The spindle motor 105 rotates while the MTON is being output.

After a definite period of time (T) has elapsed, the hold signal generating section 204a turns OFF the hold signal to release the holding state (YES in step S203), and again reduces (current change) the actuator driving current 207 (207b1) (step S204).

When the focus of the blue light source 125 approaches the information recording surface 110b and the focus error signal 201 (FEB) reaches a so-called zero cross point (point 201c in focus error signal 201 and point 207c in actuator driving current 207), that is, when the focus error signal 201 (FEB) changes from positive to zero and then to negative (step S205) (see FIG. 3A, correspond to state c), the signal FON is issued in the controller 204, the focus control loop is closed, and the focus control beings (step S105).

In the optical disk 101, the process proceeds to step S107 if the presence of the information recording surface 110b of BD standard is not recognized. In steps S107, S108, S109, S110, S111, S112, S113, S206, S207, S208, S209, and S210, the presence of the information recording surface 110r of the DVD standard is examined using the red light source 126, and if present, the focusing is performed on the information recording surface 110r and the processes until closing the focus loop are performed, similarly to processes (steps S101 to S106, and steps S201 to S205) on the blue light source 125 of the first embodiment and the second embodiment.

In the optical disk 101, if the presence of the information recording surface 110r of DVD standard is not recognized, the process proceeds to step S114. In steps S114, S115, S116, S117, S118, S119, S120, S121, S211, S212, S213, S214, and S215, the presence of the information recording surface 110ir of CD standard is examined using the infrared light source 127, and if present, the focusing is performed on the information recording surface 110ir and the processes until closing the focus loop are performed, similarly to the processes (steps S101 to S113 and steps S201 to S210) on the blue light source 125 and the red light source 126 in the first embodiment and the second embodiment. The controller 204 issues an “error” if the presence of the information recording surface 110ir of CD standard is not recognized, similarly to the first embodiment.

According to the present embodiment, deterioration of the information recording surfaces 110b, 110r and 111r of the optical disk 101 by the laser light emitted from the light sources 125, 126 and 127 in time of focusing is prevented. The diameter of the spot collected at the objective lens 121 of NA0.85, for example, is about lambda_B/NAB=0.405/0.85=0.48 micrometers. The beam spot diameter of when defocused by about 1 micrometer away from the focus in an optical axis direction is 1×0.85×2/1.5=1.13 micrometers (index of refraction of disk protective layer is 1.5), which is an irradiation amount of 1/5.6 in terms of energy density, and thus the damages on the recording films formed on the information recording surfaces 110b, 110r and 110ir can be greatly alleviated even if the optical disk 101 is in the stationary state. The optical disk 101 is rotated while maintaining the defocused state and the focus control is performed at a timing at which a predetermined rotation speed is reached after a definite period of time (T), whereby the damages on the recording films are further alleviated since the optical disk is in a non-stationary state.

The definite period of time (T) refers to a sufficient time for the motor 105 to reach a constant number of rotations. Although this depends on the torque of the motor 105, about one second is sufficient for a consumer player or recorder. The focusing can be started even if the motor 105 has not reached the predetermined number of rotations if the laser power in time of focusing is lower than in reproducing the information. This is because the damages on the information recording surfaces 110b, 110r and 110ir are considered to be small even at a low speed. For example, if the laser power in time of focusing is set to half of that in time of reproduction, the focus can be drawn in when reaching the number of rotations half the predetermined number of rotations. The time elapsed from the start of rotation of the motor 105 and the number of rotations of the motor 105 are not in a linear proportional relationship during the period from the start of the motor 105 until reaching a constant speed rotation, and the number of rotations is roughly proportional to the square root of the elapsed time. About ¼ of the time required to reach the number of rotations necessary in time of reproduction must be elapsed to reach the number of rotations of half the predetermined number of rotations. If one second is required to reach the predetermined number of rotations required in reproduction, 0.25 seconds is required to reach half the number of rotations. Therefore, in this case, T=0.25 sec.

Therefore, in the present embodiment, the damages on the information recording surfaces 110b, 110r and 110ir are suppressed as much as possible even if the focusing is started from the state in which the optical disk 101 is stationary.

### Third Embodiment

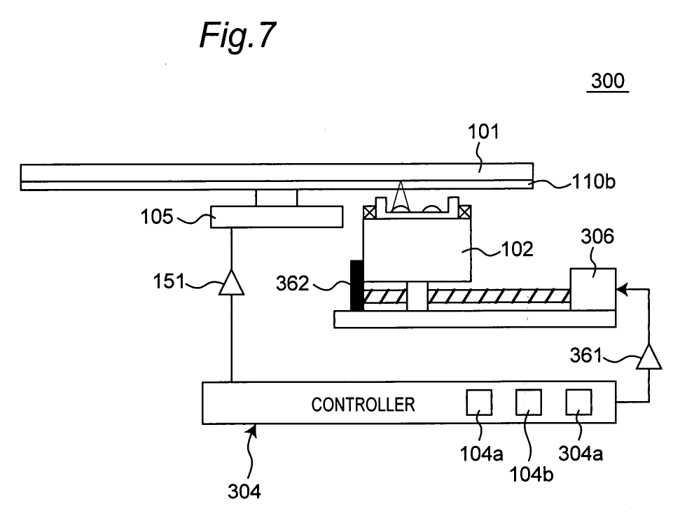

FIG. 7 is a schematic diagram of configuration of an optical disk device according to the third embodiment of the present invention. With reference to FIG. 7, the optical disk device 300 further includes a motor driver 361, a motor 306 and a stopper 362. A controller 304 issues a command to the motor driver 361, and the motor 306 performs the operation of moving the optical head 102 to the inner periphery side of the optical disk 101 (e.g., so that light emitted by light sources 125, 126 or 127 is irradiated onto a pre-pit area) according the command. The controller 304 has an innermost periphery movement command generating section 304a, which generates a command to move the optical head 102 toward the inner periphery side, further arranged in the controller 104 of the first embodiment. The stopper 362 is arranged on the inner periphery side of the optical disk 101 at a position that contacts the optical head 102, so that the optical head 102 moved toward the inner periphery side by the motor 306 contacts the stopper 362. The stopper 362 suppresses further movement of the contacted optical head 102 to the inner periphery side, and sends a signal to the controller 304 when detecting the contact of the optical head 102 and the stopper 362 with a sensor (not shown) preferably arranged in the stopper 362 or in the vicinity of the stopper 362 so as to be able to perform sensing. Other than this aspect, the optical disk device 300 may have a configuration similar to the optical disk device 100 of the first embodiment.

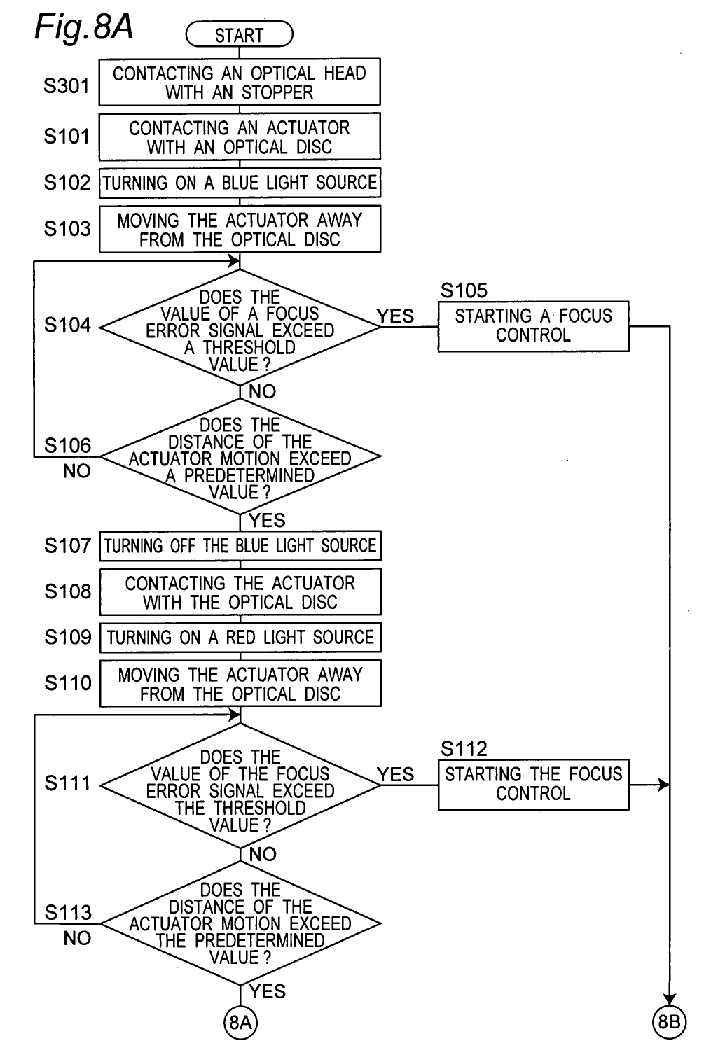

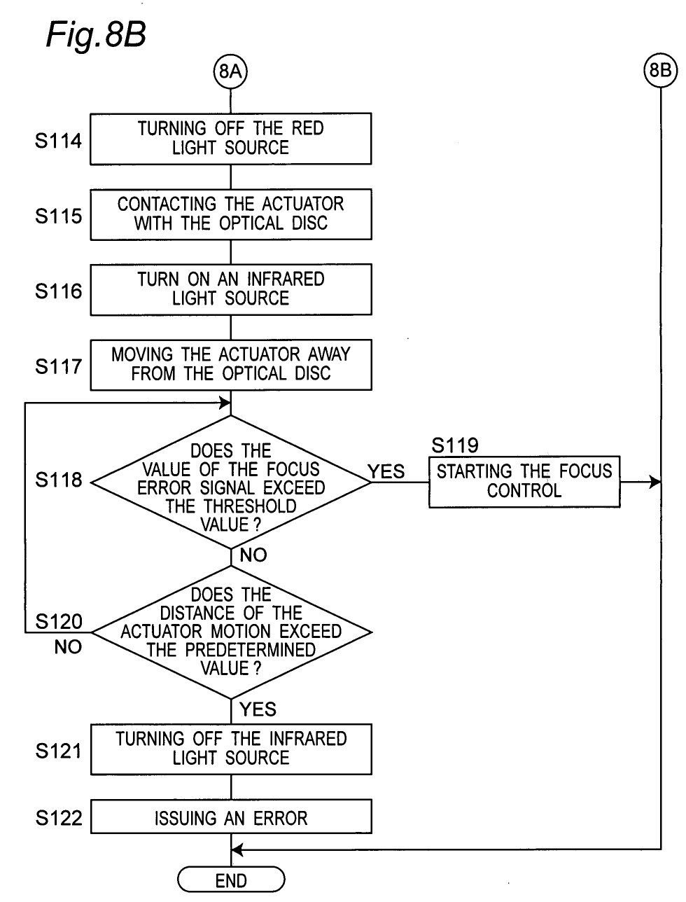

FIGS. 8A and 8B are flow charts of the focusing method according to the third embodiment of the present invention. FIGS. 8A and 8B differ from the flow chart of FIGS. 2A and 2B in that a process (step S301) of moving the optical head 102 toward the inner periphery side until contacting the stopper 362 arranged on the innermost periphery is provided before the operation of focusing (before step S101). That is, with reference to FIG. 7, the innermost periphery movement command generating section 304a of the controller 304 issues a command to the motor driver 361, and the motor 306 starts the operation of moving the optical head 102 toward the inner periphery side of the optical disk 101 according to such command (step S301 of FIG. 8A). The optical head 101 contacts the stopper 362 when reaching the innermost periphery and thereafter, the position of the optical head 102 is fixed at a position same as the position of the innermost periphery (e.g., pre-pit area) on which information is recorded of the optical disk 101 in regards to the position in the radial direction of the major surface of the optical disk 101. A sensor (not shown) for detecting the contact of the optical head 102 with the stopper 362 and stopping the motor 306 once is desirably arranged. The processes after step S101 are the same as the first embodiment, and thus the description thereof will be omitted. The processes may be the same as the processes after step S101 in the second embodiment.

Generally, the innermost periphery of the optical disk 101 is not used as the general information recording region, and information is recorded in a laser non-erasable form by emboss pit, groove wobble or the like. If the collected light is irradiated onto the relevant region in a disk stationary state, problems do not substantially arise even if collected light that may locally damage particularly the recording film is irradiated onto the information recording surfaces 110b, 110r and 110ir since information is not originally recorded on the relevant region.

Therefore, according to the present embodiment, a reliable focusing operation can be performed without damaging the information recorded on the optical disk 101 by moving the optical head 102 to the innermost periphery position of the optical disk 101 in advance.

### Fourth Embodiment

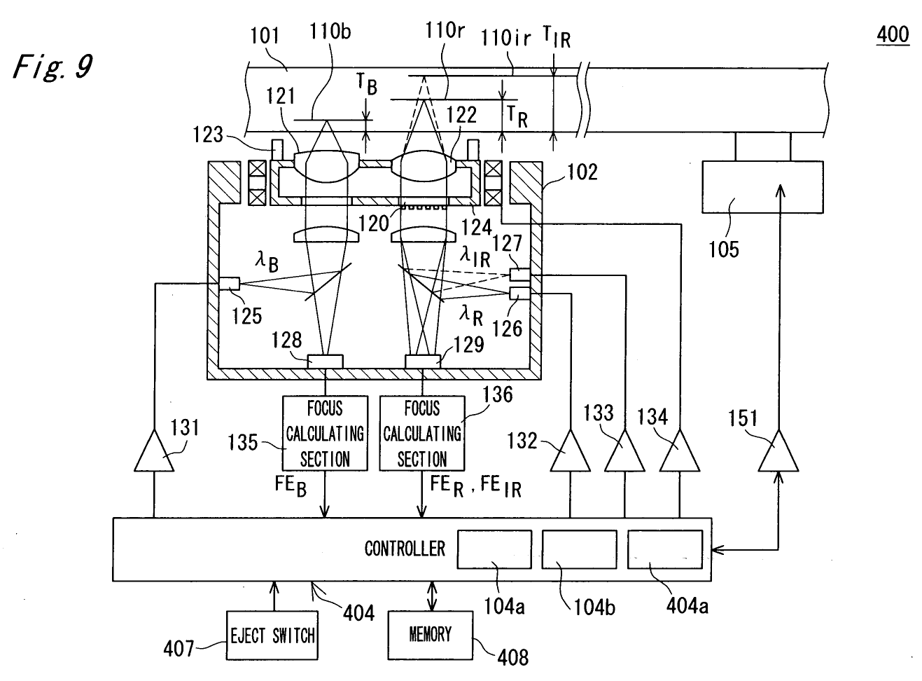

FIG. 9 is a schematic diagram of configuration of an optical disk device according to the fourth embodiment of the present invention. The optical disk device 400 of the present embodiment further includes an eject switch 407 used in retrieving the mounted optical disk 101, mounting the optical disk 101 or the like and a memory 408 for storing the state of the eject flag related to the pressed history of the eject switch 407 and the result of determination of the optical disk type performed right before. The eject switch 407 and the memory 408 are connected to the controller 404. In the present embodiment, the controller 404 has an eject flag determining section 404a included in the controller 104 of the first embodiment, the controller 204 of the second embodiment, or the controller 304 of the third embodiment. The eject flag is a flag that turns ON the eject flag to be hereinafter described in the memory 408 when the eject switch 407 is pressed. The eject flag determining section 404a appropriately detects the state of the eject flag under the control of the controller 404.

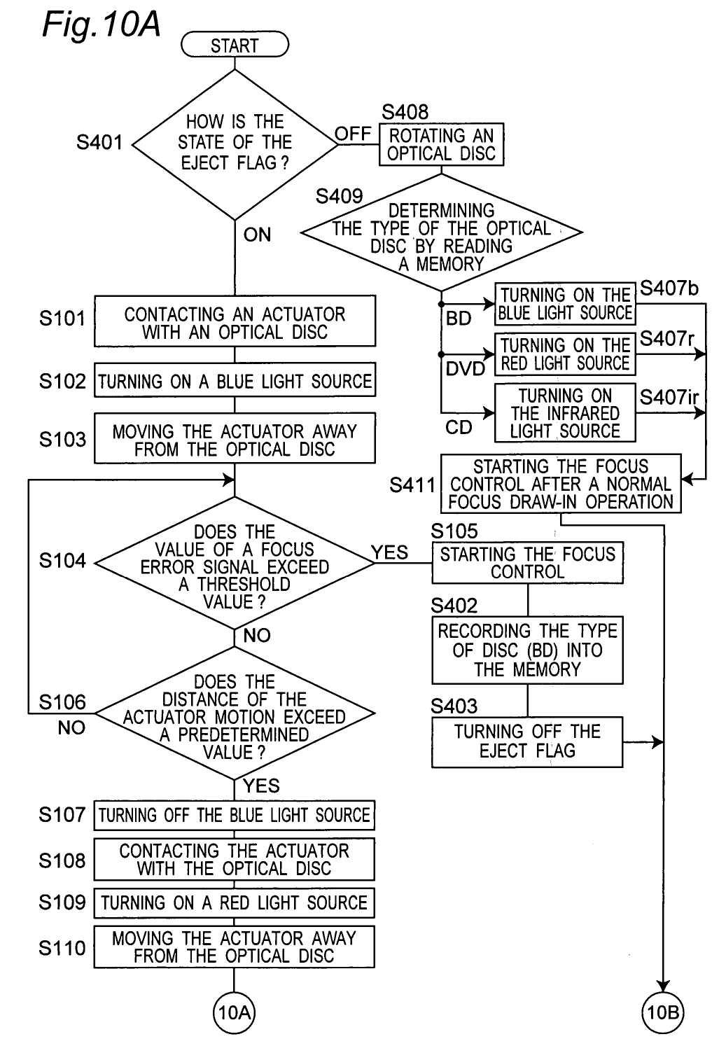

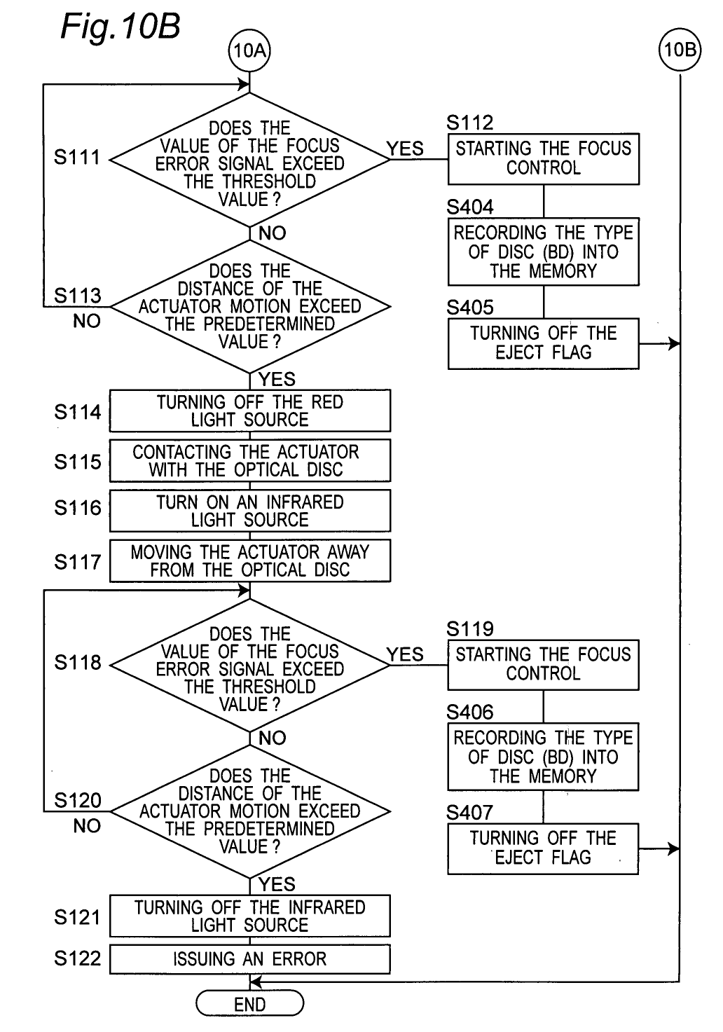

FIGS. 10A and 10B are flow charts of focusing method according to the fourth embodiment of the present invention. FIGS. 10A and 10B differ from FIGS. 2A and 2B in that a step (step S401) of referencing the pressed history of the eject switch (407 in FIG. 9) from the memory (408 in FIG. 9) and branching the subsequent processes based on the reference result is provided. When determined as “eject switch not pressed” (NO in step S401) with reference to the pressed history, the processes after step S401 are executed, whereas the processes after step S101 are executed when determined as “eject switch pressed” (YES in step S401) with reference to the pressed history. The determining criteria for the determination of “eject switch not pressed” and “eject switch pressed” will be hereinafter described.

The eject flag determining section of the controller 404 examines whether or not the eject switch has been pressed (state of eject flag) (step S401).

If the eject flag is turned ON (ON in step S401), the eject switch 407 is pressed and the optical disk 101 is assumed to be mounted. Thus, there is a possibility that the optical disk 101 different from the optical disk in time of focusing operation performed right before the eject switch 407 is pressed is mounted. Thus, the present device 400 determines the optical disk and executes the focusing operation corresponding to the disk type (BD, DVD or CD).

In this case, the controller 404 executes step S101. Furthermore, the steps S101, S102, S103, S104, S105, S106, S107, S108, S109, and S110 in FIG. 10A as well as S111, S112, S113, S114, S115, S116, S117, S118, S119, S120, S121, and S122 in FIG. 10B may be the same as the first embodiment. The description of the relevant steps will thus be omitted in the present embodiment.

Being different from the first embodiment, a step (steps S402, S404, and S406) of writing the result of disk determination, that is, the type of the currently mounted optical disk 101 into the memory 408, and a step (steps S403, S405, and S407) of turning OFF the eject flag to be hereinafter described are provided in the present embodiment.

In step S401, the criteria for determining as “eject switch pressed” is whether there is a history that the eject switch 407 has been pressed. When referring to the history being pressed, the flag (eject flag) related to the event associated with the eject pressing is turned ON. For example, “eject switch pressed” may be a case when pressing the eject switch 407, turning OFF the power of the optical disk device 400 immediately after the optical disk is changed, and again turning ON the power. Specifically, when the eject switch is pressed, the controller 404, desirably stores to a non-volatile memory (e.g., memory 408) the flag (“eject flag”) of the event thereof by turning ON the flag or the like. Thereafter, the eject flag is desirably turned OFF at the point when the focusing is successfully finished.

The criteria for determining “eject switch not pressed” in step S401 is, for example, that the eject flag is turned OFF. Specifically, it refers to a case when the focusing operation of right before is successfully finished and the eject switch is not pressed thereafter. In this case, the optical disk is assumed to have not been changed from the previous focusing operation, and thus the disk determining process does not need to be performed again.

When determined as OFF in step S401, the optical disk device 400 starts the rotation of the optical disk 101 (step S405). The controller 404 reads the information regarding the standard of the optical disk 101 currently mounted on the optical disk device 400 from the memory 408 (step S406). One of the laser light sources for blue (in case of BD), red (in case of DVD), or infrared (in case of CD) is then turned ON (step S407b, S407r or S407ir) according to the content of the memory 408.

The focusing process is thereafter performed, in which case, the process of contacting the contact preventing member 123 of the actuator 124 to the optical disk 101 as in steps S101, S108, and S115 is not necessary. This is because the determination of the type of the optical disk 101 has already been made, and the normal focusing process and the focus control corresponding to the relevant type simply need to be started. The spindle motor 5 is desirably rotated in advance (step S405), in which case the deterioration of the information recording surfaces 110b, 110r, and 110ir by the reproduction light does not occur.

The focusing operation uses a well-known method in the present embodiment. That is, the controller 404 gradually approaches the (objective lens) actuator 124 toward the optical disk 101 and closes the loop of the focus control (starts focus control) at a timing when the S shape of the focus error signal is detected (step S411).

Therefore, according to the present embodiment, subsequent focusing can be easily and rapidly performed by effectively using the result of the disk determining process that has already been performed once.

The optical disk device of the present invention is not limited to the optical disk device corresponding to the medium standards of three types such as BD, DVD and CD. The present invention is also applicable to an optical disk device corresponding to the medium standards of two types of BD and DVD. The present invention is further applicable to an optical disk device corresponding to the medium standards of two types of BD and CD or DVD and CD.

### INDUSTRIAL APPLICABILITY

The focusing method and the optical disk device according to the present invention are effective as an optical disk recorder, an optical disk player, or a personal computer (PC) optical disk drive being capable of recording to or reproducing from BD, DVD and CD.

1-13. (canceled)

14. An optical disk device comprising:
a first light source that exits a light of first wavelength with respect to an optical disk having a recording layer corresponding to light of the first wavelength and/or a recording layer corresponding to light of the second wavelength;
a second light source that exits light of the second wavelength with respect to the optical disc;
a first objective lens and a second objective lens that collects light of the first wavelength and light of the second wavelength, respectively, at a predetermined position;
an actuator that supports said first objective lens and said second objective lens and that is movable between a first position close to a mounted optical disk and a second position away therefrom;
a focus detector that receives the light of the first wavelength and the light of the second wavelength, and outputs a signal corresponding to state of received light;
a focus calculator that receives the output of said focus detector and outputs a focus error signal; and
a controller that receives the focus error signal, which is an output from said focus calculator, and controls turning ON of said first light source and said second light source, and a position of said actuator in a first direction substantially perpendicular to a major surface of the mounted optical disk; and
wherein:
a light collecting position of the light of the first wavelength at the first position is positioned between the recording layer corresponding to the light of the first wavelength and the recording layer corresponding to the light of the second wavelength;
the controller includes a focus error signal determining section; and
said focus error signal determining section detects a semi-focused state from the focus error signal outputted from said focus calculator while said actuator moves from the first position to the second position.

15. The optical disk device according to claim 14, wherein:
said actuator includes a contact preventing member configuring one part of a surface of said actuator; and
at least one portion of said contact preventing member configures a closest end of said actuator with respect to the mounted optical disk.

16. The optical disk device according to claim 14, wherein the first position is a position where the closest end configured with said contact preventing member of said actuator contacts the mounted optical disk.

17. The optical disk device according to claim 14, wherein said controller includes a hold signal generating section for generating a hold signal for having said actuator be in a stationary state over a predetermined period.

18. The optical disk device according to claim 14, further comprising:
a motor that moves said actuator in a second direction perpendicular to the first direction and parallel to the radial direction of the mounted optical disk; and
a stopper that suppresses the movement in the second direction of the optical disk or the direction toward the inner peripheral part of the mounted disk at a predetermined position; and
wherein said controller further includes an innermost periphery movement command generating section, controls said motor, and moves said actuator in the second direction to a position contacting said stopper.

19. The optical disk device according to claim 14, further comprising an eject switch; and a non-volatile memory, and
wherein said controller stores an eject flag related to a pressed history of said eject switch in the non-volatile memory and further includes an eject flag determining section that determines state of the eject flag.

20. The optical disk device according to claim 14, further comprising:
a spindle motor that rotates the mounted optical disk, and
wherein said controller controls rotation of said spindle motor and has said focus error signal determining section perform detection of a semi-focused state with said spindle motor in stopped state.

21. A focusing method for focusing in an optical disk device including a plurality of light sources emitting light of wavelengths different from each other with respect to an optical disc having a recording layer corresponding to light of first wavelength and/or a recording layer corresponding to light of second wavelength and/or a recording layer corresponding to light of third wavelength, an actuator which supports the plurality of light sources and is movable between a first position close to the optical disk and a second position away therefrom, a means for generating a focus error signal based on the light emitted by at least one of the plurality of light sources, and a controller which controls the plurality of light sources and the actuator and can receive the focus error signal, comprising:
moving the actuator to the first position in a first direction, which is a direction substantially perpendicular to a major surface of the mounted optical disk;
turning ON a first light source of the plurality of light sources;
monitoring a first focus error signal based on a light emitted by the first light source and closing a focus control loop when detecting a semi-focused state while moving the actuator from the first position to the second position;
turning ON a second light source of the plurality of light sources;
monitoring a second focus error signal based on a light emitted by the second light source and closing a focus control loop when detecting a semi-focused state while moving the actuator from the first position to the second position;
turning ON a third light source of the plurality of light sources; and
monitoring a third focus error signal based on a light emitted by the third light source and closing a focus control loop when detecting a semi-focused state while moving the actuator from the first position to the second position.

22. The focusing method according to claim 21, wherein the mounted optical disk is in a stationary state during said monitoring a first focus error signal, said monitoring a second focus error signal, and said monitoring a third focus error signal.

23. The focusing method according to claim 21,
wherein:
the first light source emits a light having a wavelength of around 405 nanometers;
the second light source emits a light having a wavelength of around 650 nanometers; and
the third light source emits a light having a wavelength of around 780 nanometers.

24. The focusing method according to claim 21, wherein:
the actuator includes a contact preventing member configuring one part of the surface of the actuator and at least one portion of the contact preventing member configuring a closest end of the actuator with respect to the mounted optical disk; and
said moving the actuator to the first position includes moving the actuator to the first position which is the position where the closest end of the actuator contacts the mounted optical disk.

25. The focusing method according to claim 21, wherein:
the optical disk device includes a spindle motor for rotating the mounted optical disk;
the controller can control the spindle motor; and
said monitoring a first focus error signal includes stopping the movement of the actuator over a predetermined period when a semi-focused state is detected, starting the rotation of the spindle motor connected to the mounted optical disk, releasing the stopping of the actuator after a predetermined period has elapsed, and closing the loop of the focus control loop.

26. The focusing method according to claim 21, wherein:
the optical disk device includes a motor for moving the actuator in a direction substantially perpendicular to the first direction and substantially parallel to a second direction which is the radial direction of the mounted optical disk and a stopper for suppressing the movement of the actuator in the second direction;
the controller can control the motor; and
the method further comprises:
moving the actuator in a direction substantially perpendicular to the first direction and substantially parallel to the second direction which is the radial direction of the mounted optical disk; and
stopping the movement of the actuator at a position where the light emitted by the first light source and the second source is irradiated onto a predetermined region positioned on the innermost peripheral part of the mounted optical disk.
